(19) United States
(12) Patent Application Publication
(10) Pub. No.: US 2014/0199154 A1
(43) Pub. Date: Jul. 17, 2014

(54) LIFTING SYSTEM FOR LIFTING AN ITEM

(71) Applicant: HEEREMA MARINE CONTRACTORS NEDERLAND SE, Leiden (NL)

(72) Inventors: Guido Johannes Maria Ammerlaan, Leiden (NL); Onno Ludolf De Waard, Leiden (NL)

(73) Assignee: HEEREMA MARINE CONTRACTORS NEDERLAND SE, Leiden (NL)

(21) Appl. No.: 14/126,636

(22) PCT Filed: Jun. 14, 2012
(86) PCT No.: PCT/NL2012/050414

§ 371 Date: Mar. 12, 2014

Related U.S. Application Data
(60) Provisional application No. 61/498,139, filed on Jun. 17, 2011.

(30) Foreign Application Priority Data
Jun. 17, 2011 (NL) 2006963

(51) Int. Cl. B63B 27/10; B66C 23/53

(52) U.S. Cl. CPC B63B 27/10; B66C 23/53
USPC 414/800; 254/323; 212/308; 212/270

(57) ABSTRACT

A lifting system (1) for lifting an item (2) with a vessel (4) comprising a first support (5) and a second support (6), wherein the lifting system comprises an elongate lifting structure (3) comprising a first end (7) and a second end (8), an item connector constructed and arranged to in use connect the lifting structure to the item near or at the first end, a weight (21) connected to a weight connector (10) provided on the lifting structure near or at the second end, a first connector (11) constructed and arranged to connect the lifting structure (31) in use to the first support, a second connector (12) constructed and arranged to connect the lifting structure in use to the second support, wherein the first connector is located at a distance from the item connector in a direction from the first end to the second end.

The invention relates to a lifting system for lifting an item with a vessel. In practice, such a lifting system is amongst other used for lifting an item to or from a sea platform. The invention furthermore relates to a vessel comprising the lifting system. The invention furthermore relates to a method of moving an item with the lifting system.

The lifting system, the vessel and the method may comprise any feature disclosed in the figures and/or the description. The lifting system, the vessel and the method may comprise said feature independent of or in combination with one or more of the other features disclosed.

Embodiments of the lifting system, the vessel and the method will be described by way of example only, with reference to the accompanying schematic drawings in which corresponding reference symbols indicate corresponding parts, and in which:

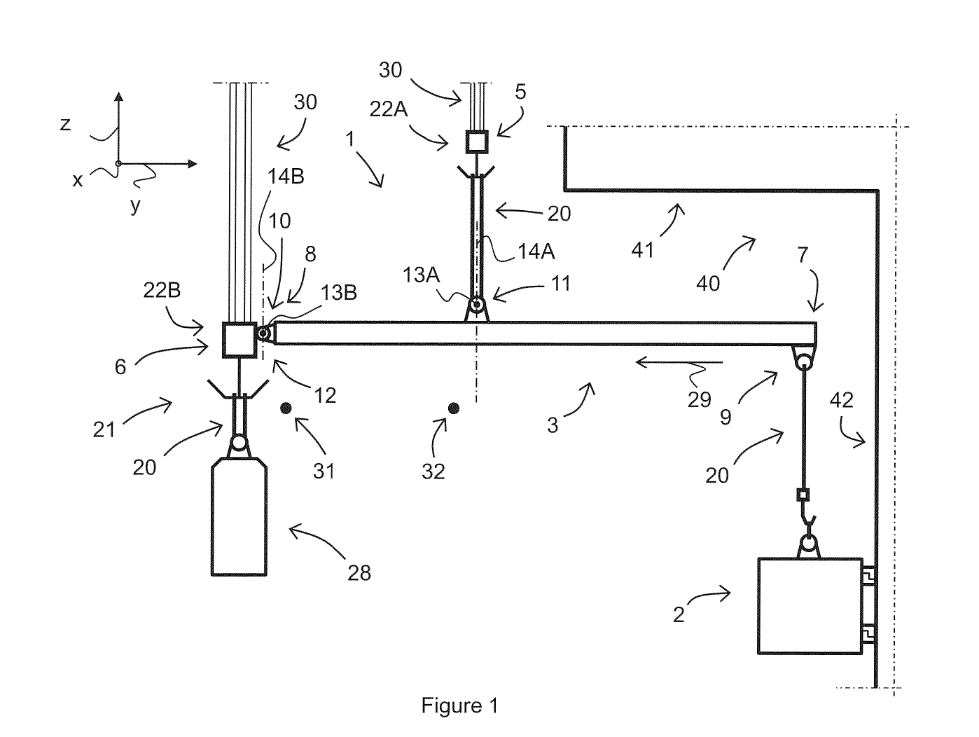

FIG. 1 schematically shows a side view of an embodiment of the lifting system,

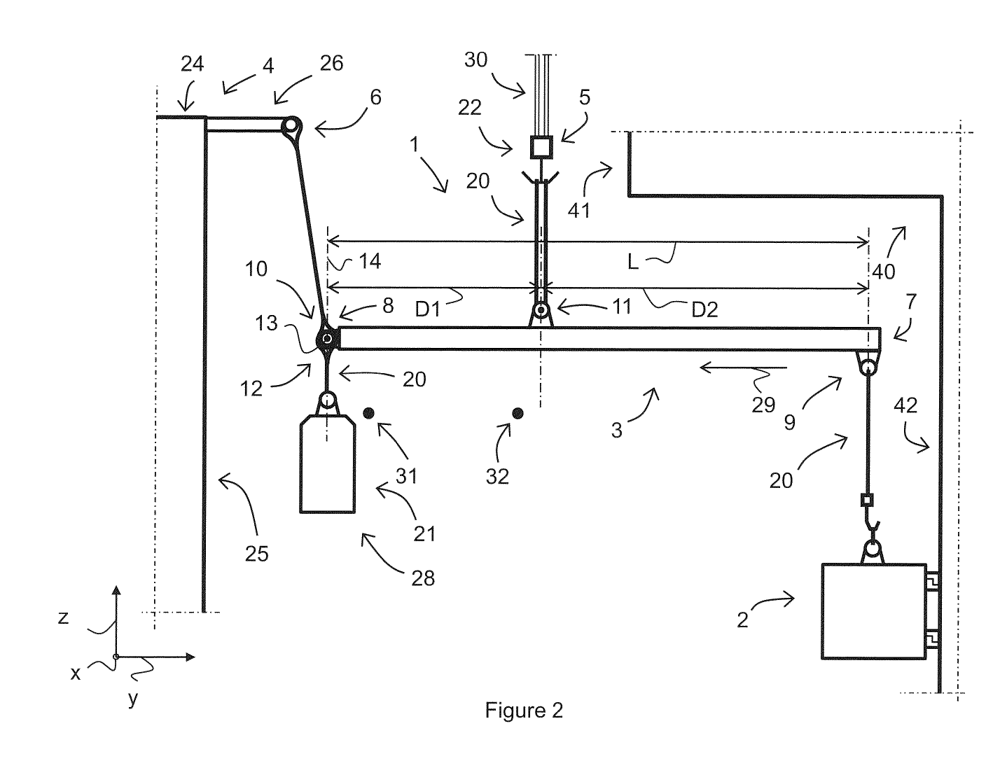

FIG. 2 schematically shows a side view of a further embodiment of the lifting system,

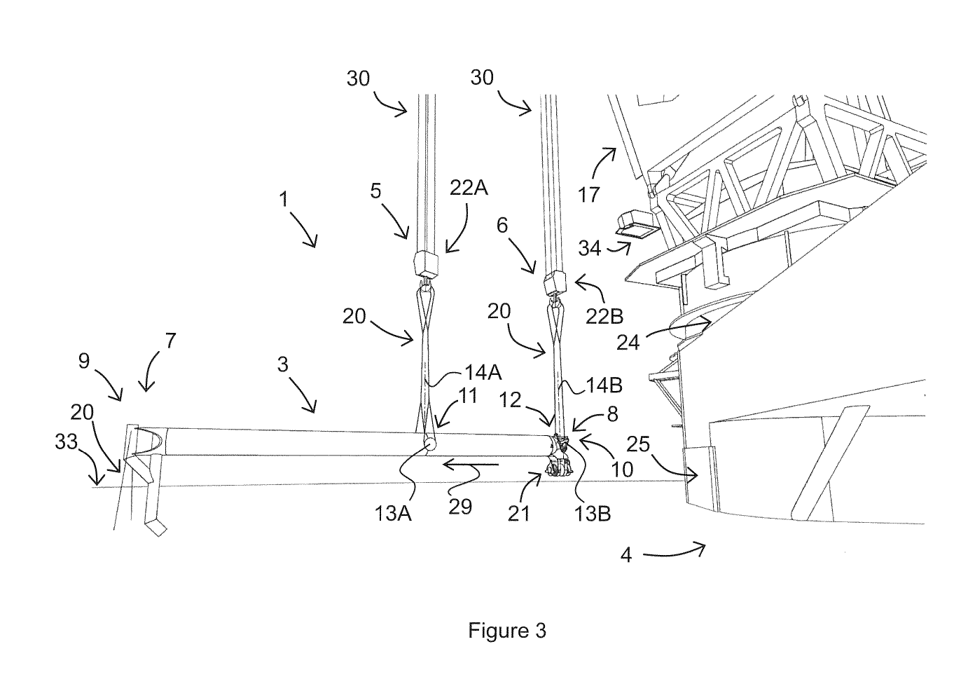

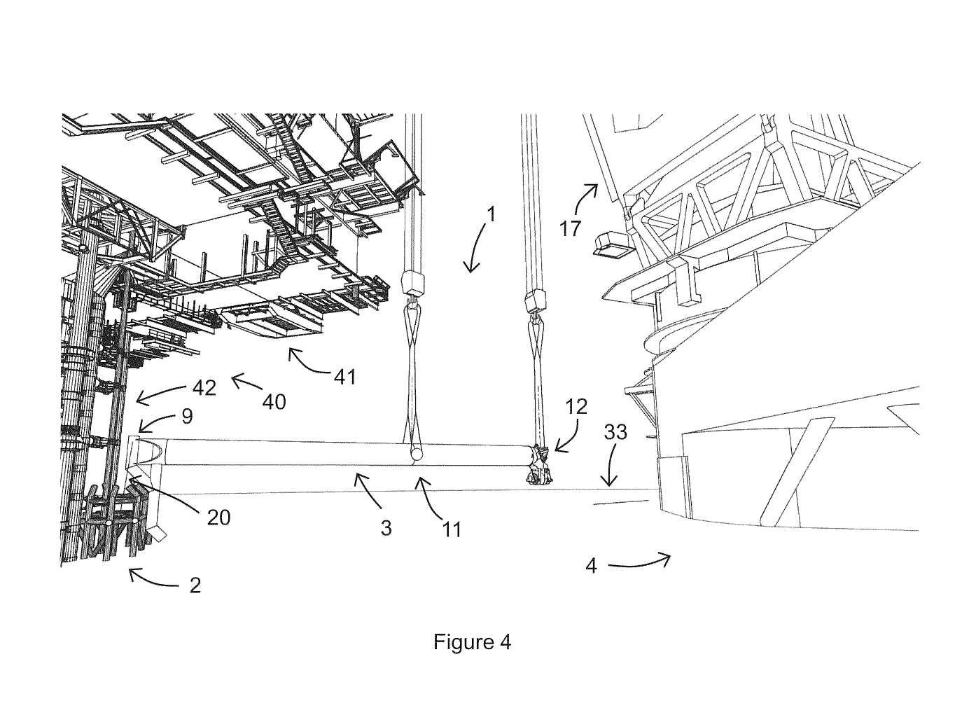

FIGS. 3 and 4 schematically show a view in perspective of a further embodiment of the lifting system, and

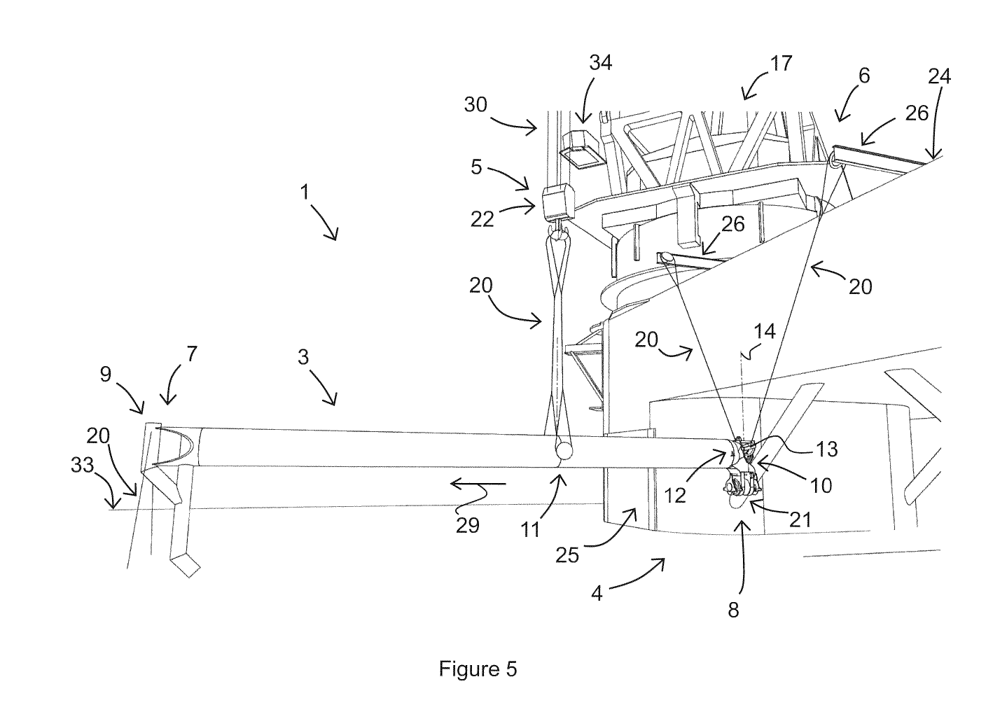

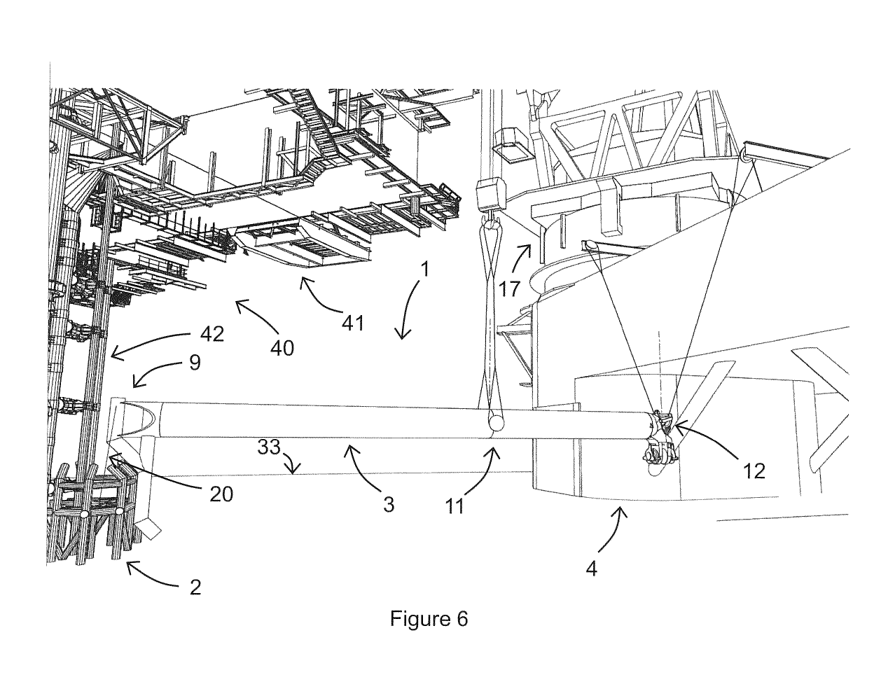

FIGS. 5 and 6 schematically show a view in perspective of a further embodiment of the lifting system.

FIG. 1 shows a side view of an embodiment of the lifting system. A co-ordinate system is indicated in the FIGS. 1 and 2. The x- and y-directions are horizontal directions and z-direction is a vertical direction.

The lifting system 1 is constructed and arranged to lift an item 2 with a vessel 4 comprising a first support 5 and a second support 6. The vessel 4 is not shown, only the first support 5 and the second support 6 of the vessel 4 are shown. In the embodiment shown in FIG. 2, part of the vessel 4 is shown.

The first support 5 and the second support 6 are each formed by a hoisting block 22A, 22B. The hoisting blocks 22A, 22B are part of a hoisting device provided on the vessel 4. The hoisting device is a crane and the hoisting block 22A, 22B are connected to an upwardly extending crane structure via hoisting wires 30. In other examples, the first support 5 is connected to a first hoisting device and the second support 6 is connected to a second hoisting device. In other examples, a different type of hoisting device is used, such as a winch. In other examples, the first support 5 and/or the second support 6 are formed by a fixed support member provided on the vessel 4.

The lifting system 1 comprises an elongate lifting structure 3 comprising a first end 7 and a second end 8 and an item connector 9 constructed and arranged to in use connect the lifting structure 3 to the item 2 at the first end 7. In other examples, the item 2 is connected to the lifting structure 1 near the first end 7.

A weight 21 is connected to a weight connector 10 provided on the lifting structure 3 at the second end 8. In other examples, the weight 21 is connected to the lifting structure 1 near the second end 8.

The lifting system 1 comprises a first connector 11 constructed and arranged to connect the lifting structure 3 in use to the first support 5 and a second connector 12 constructed and arranged to connect the lifting structure 3 in use to the second support 6.

The weight connector 10 and the second connector 12 are integrated and formed by a single connector. In other examples, the weight connector 10 and the second connector 12 are formed by separate connectors.

The first support 5 is connected to the first connector 11 via a flexible member 20. The flexible member is a flexible line. In other examples a different type of flexible member is used, such as a chain. In other examples, the first support 5 is directly connected to the first connector 11.

The second support 6 is directly connected to the second connector 12. In other examples, the second support 6 is connected to the second connector 12 via a flexible member 20.

In other examples, the first support 5 and/or the second support 6 are connected to the first connector 11 and the second connector 12 via a rigid member, such as a rigid bar.

A weight member 28 is connected to the weight connector 10 via the hoisting block 22B of the second support 6. The hoisting block 22B of the second support 6 is connected to the weight connector 10 in such a way that it's mass forms part of the weight 21 connected to the lifting structure 3. The weight 21 is therefore formed by the weight member 28 and the hoisting block 22B of the second support 6. In other examples wherein the hoisting block 22B forms part of the weight 21, the mass of the hoisting block 22B suffice and an additional mass (such as from the weight member 28) is not required. In other examples, the hoisting block 22B does not form part of the weight 21. In other examples, the weight member 28 is connected directly to the weight connector 10 or via a rigid member.

In a direction from the first end 7 to the second end 8, the first connector 11 is located at a distance from the item connector 9. Said direction is indicated by arrow 29.

A sea platform 40 comprising an upper part 41 supported by a platform support structure 42 is shown. The platform support structure 42 may for example be a steel or concrete structure standing on a seabed or floating in sea water. An item 2, such as a boat fender, a piece of pipeline or a riser, is connected to the item connector 9 and to the platform 40. The item 2 is connected to the platform 40 at a location beneath the upper part 41. The lifting system 1 reaches said location of the item 2.

The lifting system 1 allows that the item 2 is moved beneath an object, such as the upper part 41 of the platform 40. In other examples, the item is move beneath a different object restricting vertical access. In one aspect, the lifting system 1 tends to allow the installation of the item 2 at a location beneath an object and the removal of the item 2 from a location beneath an object. In one aspect, the lifting system 1 tends to allow the installation of the item 1 to a platform 40 at a location beneath the upper part 41 and the removal of the item 1 from platform 40 at a location beneath the upper part 41 (such as the top side structure of the platform).

In the direction 29 from the first end 7 to the second end 8, the second connector 12 is located beyond the first connector 11.

In the direction 29 from the first end 7 to the second end 8, the centre of gravity 31 of the lifting system 1 (mainly determined by the mass of the lifting structure 3 and the weight 21) is located at a distance from the item connector 9. In said direction 29, the centre of gravity 31 of the lifting system 1 is located beyond the first connector 11.

The second connector 12 is located between the first connector 11 and the second end 8. The second connector 12 is located at the second end 8. In other examples, the second connector 12 is located near the second end 8.

The first connector 11 is a pivot connector allowing the lifting structure 3 to in use pivot. The first connector 11 is constructed and arranged to in use allow a pivot movement of the lifting structure 3 about a pivot axis 13A which extends substantially horizontal. The first connector 11 is constructed and arranged to in use allow a pivot movement of the lifting structure 3 about a pivot axis 14A which extends substantially vertical.

The second connector 12 is a pivot connector allowing the lifting structure 3 to pivot at the second connector 12. The second connector 12 is constructed and arranged to in use allow a pivot movement of the lifting structure 3 about a pivot axis 13B which extends substantially horizontal. The second connector 12 is constructed and arranged to in use allow a pivot movement of the lifting structure 3 about a pivot axis 14B which extends substantially vertical.

The second support 6 is constructed and arranged to pivot the lifting structure 1 at the first connector 11. The first support 5 is constructed and arranged to position the lifting structure 1 in a substantially horizontal position.

The first support 5 is constructed and arranged to pivot the lifting structure 1 at the second connector 12. The first support 11 is constructed and arranged to position the lifting structure 1 in a substantially horizontal position.

The first support 5 is constructed and arranged to move the lifting structure 3 in a horizontal direction. The first support 5 is constructed and arranged to move the lifting structure 3 in a vertical direction.

The second support 6 is constructed and arranged to move the lifting structure 3 in a horizontal direction. The second support 6 is constructed and arranged to move the lifting structure 3 in a vertical direction.

For pivoting the lifting structure 3 about the first horizontal pivot axis 13A, the second support 6 is moved relative to the first support 5 in the z-direction. For pivoting the lifting structure 3 about the second horizontal pivot axis 13B, the first support 5 is moved relative to the second support 6 in the z-direction.

For moving the lifting structure 3 in a horizontal direction, the first support 5 and the second support 6 are moved in the x- or y-direction. The first support 5 and the second support 6 can be moved relative to the vessel 4 in a horizontal direction and/or the first support 5 and the second support 6 can be moved along with the vessel 4 in a horizontal direction.

For moving the lifting structure 3 in a vertical direction, the first support 5 and the second support 6 are moved in the z-direction.

For pivoting the lifting structure 3 about the first vertical pivot axis 14A, the second support 6 is moved relative to the first support 5 in the x-direction. For pivoting the lifting structure 3 about the second vertical pivot axis 14B, the first support 5 is moved relative to the second support 6 in the x-direction.

The vessel 4 comprises a controlling device 34 constructed and arranged to control the operation of the first support 5 and the second support 6. The controlling device 34 is constructed and arranged to move the first support 5 and the second support 6. The controlling device 34 forms part of the hoisting device 17. The controlling device 34 may be any type of controlling device 34 known for manually or automatically controlling the operation of a hoisting device 17, such as crane.

FIG. 2 shows a side view of a further embodiment of the lifting system 1. The lifting structure 1 is supported by a vessel 4 comprising a deck 24 and a hull 25. The first support 5 is formed by a hoisting block 22 held by a hoisting device, more specifically a crane (not shown), on the vessel 4. The second support 6 is formed by a fixed support member 26 connected to the vessel 4. The first support 5 is movable relative to the vessel 4. The second support 6 is located in a fixed position relative to the vessel 4.

In the direction 29 from the first end 7 to the second end 7, the distance between the item connector 9 and the weight connector 10 is L. The distance between the item connector 9 and the first connector 11 in said direction 29 is D2. The distance between the weight connector 10 and the first connector 11 in said direction 29 is D1.

In the shown embodiment, L is around 40 meter, D1 is around 16 meter and D2 is around 24 meter. In other examples of the lifting system 1, L is at least 20 meter. In other examples of the lifting system 1, L is at most 60 meter. In other examples of the lifting system 1, D2 is at least 0,3×L (0,3 times L). In other examples of the lifting system 1, D2 is at most 0,8×L (0,8 times L).

The lifting structure 3 is constructed and arranged to in use lift an item 2 having a mass of 5000 Kg or more. The mass of the weight 21 is larger than the mass of the item 2. The distance D1 times the mass of the weight 21 is larger than the distance D2 times the mass of the item 2.

In the direction 29 from the first end 7 to the second end 8, the centre of gravity 32 of the combination of the lifting system 1 and the thereto connected item 2 is located beyond the first connector 11. In one aspect of the lifting system 1, the lifting system 1 tends to exert a pulling force on the second support 6 via the second connector 12.

In other examples of the lifting system 1, the centre of gravity 32 of the combination of the lifting system 1 and the thereto connected item 2 is located substantially in line with the first connector 11 when seen in a vertical direction.

FIG. 3 shows a view of a further embodiment of the lifting system 1. The lifting system 1 is carried by a vessel 4 floating in sea water 33. A hoisting device 17, more specifically a crane, is provided on the vessel 4. The hoisting device 17 is provided with a controlling device 34 for controlling the operation of the hoisting device 17. The hoisting device 17 comprises a first hoisting block 22A and a second hoisting block 22B. The first hoisting block 22A forms the first support 5 and the second hoisting block 22B forms the second support 6.

FIG. 4 shows the lifting system 1 of FIG. 3 positioned near a sea platform 40. The item 2 (which in this situation is a boat fender) is located beneath the upper part 41 of the platform 40. The item connector 9 is connected to the item by flexible members 20, such as wires and/or chains.

FIG. 5 shows a view of a further embodiment of the lifting system 1. The lifting system 1 is carried by a vessel 4 floating in sea water 33. A hoisting device 17, more 30 specifically a crane, is provided on the vessel 4. The hoisting device 17 is provided with a controlling device 34 for controlling the operation of the hoisting device 17. The hoisting device 17 comprises a hoisting block 22 forming the first support 5. Two fixed support members 26 are provided on the vessel 4. Said fixed support members 26 form the second support 6.

FIG. 6 shows the lifting system 1 of FIG. 5 positioned near a sea platform 40. The item 2 is located beneath the upper part 41 of the platform 40. The item connector 9 is connected to the item by flexible members 20, such as wires and/or chains.

Referring to the FIGS. 1-6, the method of moving the item 2 with the vessel 4 comprises supporting the lifting system 1 with the first support 5 at the first connector 11 and with the second support 6 at the second connector 12, connecting the item connector 9 to the item 2, and moving the item 2 by moving the lifting system 1.

The method may comprise moving the lifting system 1 by moving the first support 5 and/or the second support 6. The method comprise moving the lifting system 1 by moving the vessel 4.

The method may comprises moving the item 2 connected to the lifting system 2 below an object. The method may comprises moving the item 2 connected to the lifting system 2 below an upper part 41 of an sea platform 40.

The method may comprise positioning the vessel 4 besides a sea platform 40 to which the item 2 is connected, moving the lifting system 1 to position the item connector 9 near the item 2, connecting the item connector 9 to the item 2, disconnecting the item 2 from the platform 40, and moving the lifting system 1 to move the item 2 away from the platform 40.

The method may comprise positioning the vessel 4 besides a sea platform 40, moving the lifting system 1 with the item 2 connected to the item connector 9 to positioning the item 2 near the platform 40, connecting the item 2 to the platform 40, disconnecting the item 2 from the item connector 9, and moving the lifting system 1 away from the platform 40.

The method may comprise moving the item 2 connected to the lifting system 1 below an upper part 41 of the platform 40.

The method may comprise pivoting the lifting structure 3 at the first connector 11. The method may comprise positioning the lifting structure 1 substantially horizontal with the second support 6.

The method may comprise pivoting the lifting structure 3 at the second connector 12. The method may comprise positioning the lifting structure 3 substantially horizontal with the first support 5.

The method may comprise moving the lifting structure 3 in a horizontal direction 15. The method may comprise moving the lifting structure 3 in a vertical direction 16.

It will be apparent to those skilled in the art that various modifications can be made to the invention without departing from the scope of the invention.

1-57. (canceled)

58. A vessel for moving an item, which vessel comprises:
a first support, a second support, and a lifting, system for lifting the item, wherein the lifting system comprises:
an elongate lifting structure comprising a first end and a second end, an item connector constructed and arranged to in use connect the lifting structure to the item near or at the first end;
a weight connected to a weight connector provided on the lifting structure near or at the second end:
a first connector constructed and arranged to connect the lifting structure in use to the first support: and
a second connector constructed and arranged to connect the lifting structure in use to the second support, wherein the first connector is located at a distance from the item connector In a direction from the first end to the second end.

59. The vessel according to claim 58, wherein the first support and second support are constructed and arranged to support the lifting structure.

60. The vessel according, to claim 58, wherein the second support is constructed and arranged to pivot the lifting structure at the first connector.

61. The vessel according to claim 58, wherein the first support is constructed and arranged to pivot the lifting structure at the second connector.

62. The vessel according to claim 58, wherein the first support is constructed and arranged to position the lifting structure in a substantially horizontal position.

63. The vessel according to claim 58, wherein the first support is constructed and arranged to move the lifting structure in a horizontal direction.

64. The vessel according to claim 58, wherein the first support is constructed and arranged to move the lifting structure in a vertical direction.

65. The vessel according to claim 58, wherein the vessel comprises at least one hoisting device providing the first support.

66. The vessel according to claim 58, wherein the vessel comprises at least one hoisting device providing the second support.

67. The vessel according to claim 58, wherein the vessel comprises a first hoisting device providing the first support and a second hoisting device providing the second support.

68. The vessel according to claim 58, wherein the vessel comprises at least one fixed support member forming the second support.

69. The vessel according to claim 68, wherein the vessel comprises at least one fixed support member forming the first support.

70. A method of moving an item with a vessel according to claim 58, which method comprises:
supporting the lifting system with the first support at the first connector and with the second support at the second connector;
connecting the item connector to the item; and
moving the item by moving the lifting system.

71. The method according to claim 70, wherein the method further comprises moving the lifting system by moving the first support and/or the second support.

72. The method according to claim 70, wherein the method further comprises moving the Item connected to the lifting system below an object.

73. The method according to claim 70, wherein the method further comprises:
positioning the vessel besides a sea platform to which the item is connected;
moving the lifting system to position the item connector near the item;
connecting the item connector to the item;
disconnecting the item from: the platform; and
moving the lifting system to move the item away from the platform.

74. The method according to claim 70, wherein the method further comprises:
positioning the vessel besides a sea platform;
moving the lifting system with the item connected to the item connector to position the item near the platform;
connecting the item to the platform;
disconnecting the item from the item connector; and
moving the lifting system away from the platform,

75. The method according to claim 74, wherein the method further comprises moving the item connected to the lifting system below an upper part of the platform.

76. The method according to claim 70, wherein the method further comprises pivoting the lifting structure at the first connector.

77. The method according to claim 70, wherein the method further comprises positioning the lifting structure substantially horizontal with the second support.
